(19) United States
(12) Patent Application Publication
(10) Pub. No.: US 2018/0046044 A1
(43) Pub. Date: Feb. 15, 2018

(54) EMBEDDED TOUCH DISPLAY PANEL AND THE MANUFACTURING METHODS THEREOF

(71) Applicant: Wuhan China Star Optoelectronics Technology Co., Ltd., Wuhan, Hubei (CN)

(72) Inventors: Yao-li HUANG, Shenzhen, Guangdong (CN); Gui CHEN, Shenzhen, Guangdong (CN); Jian-hong LIN, Shenzhen, Guangdong (CN)

(73) Assignee: Wuhan China Star Optoelectronics Technology Co., Ltd., Wuhan, Hubei (CN)

(21) Appl. No.: 14/915,227

(22) PCT Filed: Jan. 29, 2016
(86) PCT No.: PCT/CN2016/072715

§ 371 Date: Feb. 27, 2016

(30) Foreign Application Priority Data
Dec. 31, 2015 (CN) 201511028145.3

(51) Int. Cl. G02F 1/1362; G06F 3/041; G02F 1/1333; G02F 1/1368; G02F 1/1335

(52) U.S. Cl. CPC G02F 1/136204; G02F 1/1368; G02F 1/133514; G02F 1/133528; G02F 1/13338; G06F 3/0412; G02F 2202/28; G02F 2202/22; G06F 2203/04103; G06F 2203/04107

(57) ABSTRACT

An embedded touch panel and the manufacturing method thereof are disclosed. The embedded touch panel includes a TFT substrate, a liquid crystal layer, a color filter, a polarizer and a glass cover arranged in sequence, wherein the polarizer is a non-conductive polarizer. A transparent conductive layer is arranged between the polarizer and the color filter. The TFT substrate includes at least one grounded pin, and the transparent conductive layer electrically connects with the grounded pin on the TFT substrate. In view of the above, the transparent conductive layer and the non-conductive polarizer may replace the high impedance polarizer of the embedded touch panel so as to greatly reduce the manufacturing cost. In addition, by bonding the frame of the polarizer, the bubble issue occurring when bonding the polarizer may be avoided.

### BACKGROUND OF THE INVENTION

### 1. Field of the Invention

The present disclosure relates to liquid crystal display technology, and more particularly to an embedded touch panel and the manufacturing method thereof.

### 2. Discussion of the Related Art

Touch panels include On Cell Touch and In Cell Touch.

On Cell Touch relates to the technology that the touch panel is mounted on the display panel, and the touch panel may include resistive and capacitive panels, which are usually manufactured by touch panel suppliers. The touch panels are then assembled and bonded with the display panel.

In Cell Touch relates to the technology that the touch panel is integrated within the display panel. As such, the display panel may include the touch function itself, and thus additional process to bond the touch panel with the display panel is not needed. Usually, the display panel is manufactured by the TFT LCD manufacturers.

In Cell Touch manufacturing process is an important step of the panel manufacturing process, which also plays an important role of display. The manufacturing process may include cutting the panel, bonding the polarizer, the IC, and FPC, and the assembly of the backlit. The manufacturing cost of the panel may be greatly affected by the selected solution and materials in the above process.

The selection of the polarizer is a key factor of controlling the cost. Regarding the In Cell Touch process, generally, the polarizer having high impedance is selected so as to prevent the touch panel from being affected by the external electrical field. However, the cost of such polarizer is pretty high, which may increase the cost of the In Cell Touch product. Thus, how to decrease the cost of such process is an important issue to be solved.

### SUMMARY

In order to overcome the above problem, an embedded touch panel and the manufacturing method thereof are proposed.

In one aspect, an embedded touch panel includes: a TFT substrate, a liquid crystal layer, a color filter, a polarizer and a glass cover arranged in sequence, wherein the polarizer is a non-conductive polarizer, a transparent conductive layer is arranged between the polarizer and the color filter, the TFT substrate includes at least one grounded pin, and the transparent conductive layer electrically connects with the grounded pin on the TFT substrate.

Wherein the transparent conductive layer includes one or more than one transparent conductive layer of bar-shaped structures arranged between the color filter and the polarizer, and the transparent conductive layer of bar-shaped structure is arranged inside the frame of the polarizer.

Wherein the transparent conductive layer is of circular structure, one or a plurality of isolated bar-shaped structure, or a plurality of non-circular structures connected with each other.

Wherein the transparent conductive layer and the grounded pin on the TFT substrate are electrically connected by conductive Ag adhesive.

Wherein the transparent conductive layer and the polarizer are bonded by an OCA adhesive layer.

Wherein the polarizer and the glass cover are bonded by an OCA adhesive layer.

In another aspect, a manufacturing method of embedded touch panels includes: providing a TFT substrate and a color filter, forming a liquid crystal layer between the TFT substrate and the color filter, and arranging at least one grounded pin on the TFT substrate; forming a transparent conductive layer on the color filter, and electrically connecting the transparent conductive layer and the grounded pin on the TFT substrate via conductive Ag adhesive; bonding a polarizer on the transparent conductive layer via OCA adhesive, and the polarizer is a non-conductive polarizer; and bonding a glass cover on the polarizer via the OCA adhesive.

Wherein the step of electrically connecting the transparent conductive layer and the grounded pin on the TFT substrate via conductive Ag adhesive further includes:

printing an AG adhesive layer on a surface of the color filter, adopting an Ag dispense process to connect the AG adhesive on the surface of the color filter with the grounded pin on the TFT substrate, and bonding the transparent conductive layer on the Ag adhesive.

Wherein the Ag adhesive on the surface of the color filter is of circular structure, one or a plurality of isolated bar-shaped structure, or a plurality of non-circular structures connected with each other.

Wherein the transparent conductive layer is of circular structure, one or a plurality of isolated bar-shaped structure, or a plurality of non-circular structures connected with each other.

In view of the above, the transparent conductive layer and the non-conductive polarizer may replace the high impedance polarizer of the embedded touch panel so as to greatly reduce the manufacturing cost. In addition, by bonding the frame of the polarizer, the bubble issue occurring when bonding the polarizer may be avoided.

### BRIEF DESCRIPTION OF THE DRAWINGS

FIG. 1 is a schematic view of the conventional embedded touch panel.

FIG. 2 is a schematic view of the lateral structure of the embedded touch panel in accordance with a first embodiment.

FIG. 3 is a schematic view of the planer structure of the embedded touch panel in accordance with the first embodiment.

FIG. 4 is a schematic view of the planer structure of the embedded touch panel in accordance with a second embodiment.

FIG. 5 is a schematic view of the planer structure of the embedded touch panel in accordance with a third embodiment.

### DETAILED DESCRIPTION OF THE EMBODIMENTS

Embodiments of the invention will now be described more fully hereinafter with reference to the accompanying drawings, in which embodiments of the invention are shown.

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

FIG. 1 is a schematic view of the conventional embedded touch panel. The embedded touch panel include a TFT substrate 10, a liquid crystal layer 20, a color filter 30, a high impedance polarizer 40, an OCA adhesive layer 50, and a glass cover 60 arranged along a top-down direction in turn. The TFT substrate includes at least one grounded pin 11. The high impedance polarizer 40 electrically connects with the grounded pin 11 on the TFT substrate.

The manufacturing process includes the following steps. After the panel is assembled to be a cell, a huge plate is cut to be small chips. The high impedance polarizer 40 is bonded on the TFT substrate 10 and the color filter 30. After bonding the IC and the FPC, a Ag dispense process is applied to the substrate. By the Ag dispense process, the high impedance polarizer 40 connects with the grounded pin 11 on the TFT substrate. Afterward, the OCA adhesive is coated on the high impedance polarizer 40, and the glass cover 60 is bonded. Afterward, the latter portion of the embedded touch panel manufacturing process is finished. The high impedance polarizer 40 not only change the polarized direction of the light beams, but also prevents the touch panel from being affected by the external electrical field. However, the cost of the high impedance polarizer 40 is high, which may be several times than general polarizer, and thus the manufacturing cost of the embedded touch panel is greatly increased.

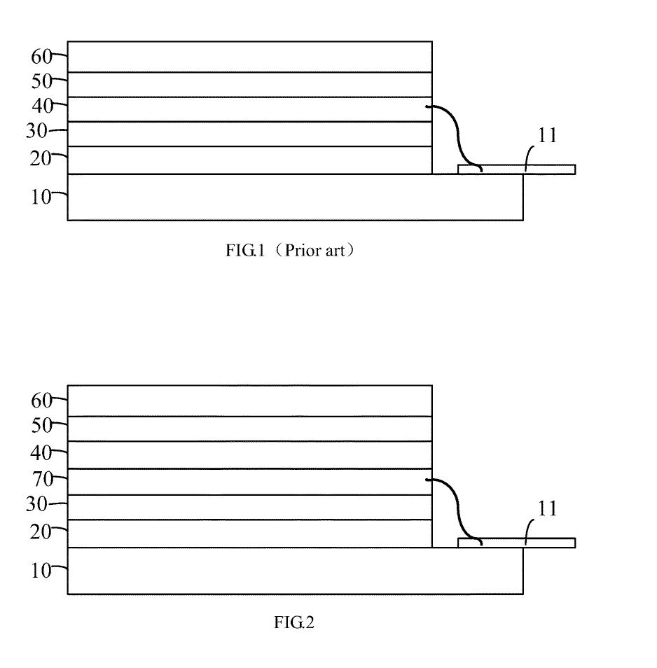

FIG. 2 is a schematic view of the lateral structure of the embedded touch panel in accordance with a first embodiment. The embedded touch panel includes the TFT substrate 10, the liquid crystal layer 20, the color filter 30, a transparent conductive layer 70, the polarizer 40, the OCA adhesive layer 50, and the glass cover 60 arranged along the top-down direction in turn. The TFT substrate includes the grounded pin 11. The polarizer 40 electrically connects with the grounded pin 11 on the TFT substrate. The high impedance polarizer 40 is not a conductive polarizer, and thus the cost is much lower than that of the high impedance polarizer 40.

Referring to FIG. 3, the dimension of the TFT substrate 10 is larger than that of the color filter 30 such that the grounded pin may be configured thereon. The transparent conductive layer 70 may be ITO layer, and is of a circular structure arranged between the color filter 30 and the high impedance polarizer 40. The transparent conductive layer 70 is arranged within the frame of the polarizer 40. The transparent conductive layer 70 and the grounded pin 11 on the TFT substrate 10 are connected by conductive Ag adhesive. The configuration of adopting the circular transparent conductive layer and general non-conductive polarizer may replace the configuration of bonding the high impedance polarizer on the color filer of FIG. 1.

Referring to FIGS. 2 and 3, the manufacturing method of the embedded touch panel includes the following steps.

Providing the TFT substrate 10 and the color filter 30, forming the liquid crystal layer 20 between the TFT substrate 10 and the color filter 30, and arranging the grounded pin 11 on the TFT substrate 10;

Forming the transparent conductive layer 70 on the color filter 30, and electrically connecting the transparent conductive layer 70 and the grounded pin 11 on the TFT substrate 10 via the conductive Ag adhesive;

Bonding the polarizer 40 on the transparent conductive layer 70 via the OCA adhesive, and the polarizer is a non-conductive polarizer;

Bonding the glass cover 60 on the polarizer 40 via the OCA adhesive layer 50.

Specifically, the transparent conductive layer 70 of a circular structure is formed on the surface of the color filter 30. As shown in FIG. 3, the Ag dispense process is applied to the borders of the transparent conductive layer 70 and the edge of the display panel. The Ag dispensed points have to span over the transparent conductive layer, the color filter and the TFT substrate. The transparent conductive layer and the grounded pin on the TFT substrate are electrically connected by the Ag adhesive. Afterward, the transparent conductive layer is coated with the OCA adhesive layer. The adhesive capability of the OCA adhesive layer is strong. The non-conductive polarizer is bonded on the OCA adhesive layer. The polarizer is coated with the OCA adhesive and then the glass cover is attached. Compared to the conventional bonding process of In Cell Touch, by bonding the frame of the polarizer, the bubble issue occurring when bonding the polarizer may be avoided.

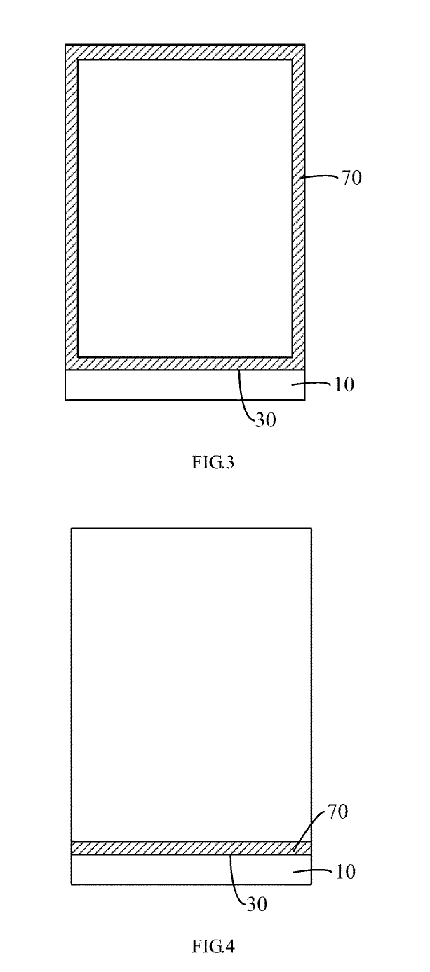

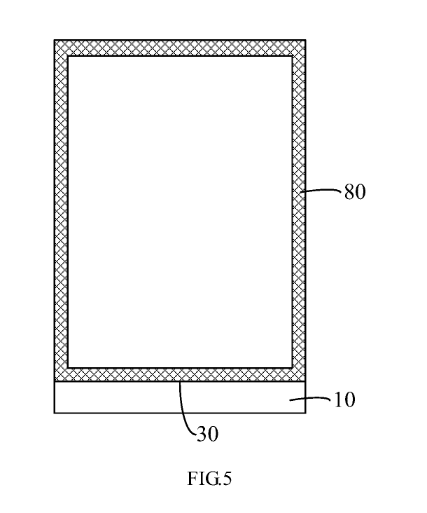

FIG. 4 is a schematic view of the planer structure of the embedded touch panel in accordance with a second embodiment. The difference between the second embodiment and the first embodiment resides in that the transparent conductive layer 70 is not of the circular structure. The transparent conductive layer 70 is of a bar structure. In other embodiments, the transparent conductive layer 70 may be the ITO layer having two parallel structures, the ITO layer having two L-shaped structure intersecting with each other, or the ITO layer having three “n”-shaped structures connected with each other. Similarly, the transparent conductive layer 70 of any shapes may electrically connect with the grounded pin on the TFT substrate 10.

Similarly, within the manufacturing method, the Ag layer has to be printed on the whole surface of the color filter 30, and the AG dispense process is adopted to connect the Ag adhesive on the surface of the color filter with the grounded pin on the TFT substrate 10. Afterward, the transparent conductive layer is manufactured above the Ag adhesive, the OCA adhesive layer is coated, and the non-conductive polarizer is bonded. In this way, the object of the first embodiment may be achieved also.

FIG. 5 is a schematic view of the planer structure of the embedded touch panel in accordance with a third embodiment. In the embodiment, the frame of the color filter 30 is printed with the circular Ag adhesive via screen printing. Afterward, the Ag dispense process is adopted to connect the Ag adhesive on the surface of the color filter with the grounded pin on the TFT substrate 10. Afterward, the transparent conductive layer 70 is manufactured above the Ag adhesive, the OCA adhesive layer is coated, and the non-conductive polarizer is bonded. In this way, the object of the first embodiment may be achieved also.

Preferably, the shape of the transparent conductive layer 70 may be the same with the second insulation layer 80. It can be understood that, in other embodiments, the shape of the transparent conductive layer may be the ITO layer having two parallel structures, the ITO layer having two L-shaped structure intersecting with each other, or the ITO layer having three “n”-shaped structures connected with each other.

Further, when the transparent conductive layer is of non-circular structure, the corresponding Ag adhesive may be of non-circular structure as long as the Ag adhesive is capable of supporting the transparent conductive layer.

In view of the above, the transparent conductive layer and the non-conductive polarizer may replace the high impedance polarizer of the embedded touch panel so as to greatly reduce the manufacturing cost. In addition, by bonding the frame of the polarizer, the bubble issue occurring when bonding the polarizer may be avoided.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An embedded touch panel, comprising:
a TFT substrate, a liquid crystal layer, a color filter, a polarizer and a glass cover arranged in sequence, wherein the polarizer is a non-conductive polarizer, a transparent conductive layer is arranged between the polarizer and the color filter, the TFT substrate comprises at least one grounded pin, and the transparent conductive layer electrically connects with the grounded pin on the TFT substrate.

2. The embedded touch panel as claimed in claim 1, wherein the transparent conductive layer comprises one or more than one transparent conductive layer of bar-shaped structures arranged between the color filter and the polarizer, and the transparent conductive layer of bar-shaped structure is arranged inside the frame of the polarizer.

3. The embedded touch panel as claimed in claim 2, wherein the transparent conductive layer is of circular structure, one or a plurality of isolated bar-shaped structure, or a plurality of non-circular structures connected with each other.

4. The embedded touch panel as claimed in claim 1, wherein the transparent conductive layer and the grounded pin on the TFT substrate are electrically connected by conductive Ag adhesive.

5. The embedded touch panel as claimed in claim 1, wherein the transparent conductive layer and the polarizer are bonded by an OCA adhesive layer.

6. The embedded touch panel as claimed in claim 1, wherein the polarizer and the glass cover are bonded by an OCA adhesive layer.

7. A manufacturing method of embedded touch panels, comprising:
providing a TFT substrate and a color filter, forming a liquid crystal layer between the TFT substrate and the color filter, and arranging at least one grounded pin on the TFT substrate;
forming a transparent conductive layer on the color filter, and electrically connecting the transparent conductive layer and the grounded pin on the TFT substrate via conductive Ag adhesive;
bonding a polarizer on the transparent conductive layer via OCA adhesive, and the polarizer is a non-conductive polarizer; and
bonding a glass cover on the polarizer via the OCA adhesive.

8. The manufacturing method as claimed in claim 7, wherein the step of electrically connecting the transparent conductive layer and the grounded pin on the TFT substrate via conductive Ag adhesive further comprises:
printing an AG adhesive layer on a surface of the color filter, adopting an Ag dispense process to connect the AG adhesive on the surface of the color filter with the grounded pin on the TFT substrate, and bonding the transparent conductive layer on the Ag adhesive.

9. The embedded touch panel as claimed in claim 8, wherein the Ag adhesive on the surface of the color filter is of circular structure, one or a plurality of isolated bar-shaped structure, or a plurality of non-circular structures connected with each other.

10. The embedded touch panel as claimed in claim 8, wherein the transparent conductive layer is of circular structure, one or a plurality of isolated bar-shaped structure, or a plurality of non-circular structures connected with each other.
